(19) United States
(12) Patent Application Publication
(10) Pub. No.: US 2007/0143234 A1
(43) Pub. Date: Jun. 21, 2007

(54) Method and system for intelligent model-based optical proximity correction (OPC)

(75) Inventors: Wen Chun Huang, Xigang Shiang (TW); Ru Gun Liu, Yongkang City (TW); Chih Ming Lai, Hsinchu City (TW)

Correspondence Address: HAYNES AND BOONE, LLP, 901 MAIN STREET, SUITE 3100, DALLAS, TX, 75202, US

(73) Assignee: Taiwan Semiconductor Manufacturing Company, Ltd., Hsin-Chu (TW)

(21) Appl. No.: 11/305,582

(22) Filed: Dec. 16, 2005

(51) Int. Cl. G06N 3/02

(52) U.S. Cl. 706/15

(57) ABSTRACT

Aspects of the present disclosure provide a method and a system for an intelligent model-based OPC. Good initial edge shift estimates are generated using an empirical model. A training system with a training function is used to provide initial edge shift estimates to the empirical model. The training system continuously improves as corrected patterns are added to the pattern library from the output layout file.

### BACKGROUND

Optical proximity correction (OPC) is a technique of distorting mask layouts of a wafer so that the printed patterns are as close to the desired shape as possible. Model-based OPC is a technique that employs a lithographic model to predict edge positions or contours of the patterns after the lithography process. Before correction occurs, edges of the patterns are dissected into small segments and a target point is defined for each segment. During the correction, the edges are moved back and forth from drawn positions initially based on the lithographic model. The edges eventually converge to their final positions to make the contour meet the target points. Usually, several iterations are needed in order to achieve a convergence between the edge positions and the target points. As the number of iterations increases, computation time also increases. A need exists for a technique that reduces the number of iterations required to reach a convergence, such that computation time and resource consumption can be minimized.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a pictorial representation of a network of data processing systems in which an embodiment of the present disclosure may be implemented.

FIG. 2 is a block diagram of an embodiment of an intelligent model-based OPC.

FIG. 3 is a process flowchart of an embodiment of the intelligent model-based OPC of FIG. 2.

FIG. 4A is a diagram illustrating an exemplary artificial neural network used as a training system of an embodiment of the intelligent model-based OPC of FIG. 2.

FIG. 4B is a diagram of an exemplary training function for use by artificial neural network 400.

FIG. 5 is a diagram illustrating an exemplary initial training set of the empirical model and exemplary initial edge shift estimates predicted by the empirical model.

FIG. 6 is a diagram illustrating a design input 600 with no OPC.

### DETAILED DESCRIPTION

Aspects of the present disclosure provide a method and a system for intelligent model-based OPC. In an illustrative embodiment, the aspects of the present disclosure provide “good initial estimates” of edge positions, such that the number of iterations required to achieve a convergence is reduced. Good initial estimates of edge positions are OPC adjustments that advance the design of pattern templates and segments towards a final position. In order to provide good initial estimates, aspects of the present disclosure utilize an artificial neural network model to build a mapping of segment characteristics to edge offset from the drawn positions. However, other types of control models may also be used without departing the spirit and scope of the present disclosure, for example, a support vector machine (SVM) As the artificial neural network is continuously trained with updated patterns, the artificial neural network provides a good initial estimate for each segment to which the correction is applied. Good initial estimates lead to a reduction of iterations required to reach a convergence, and a reduction in cycle time and computing resources.

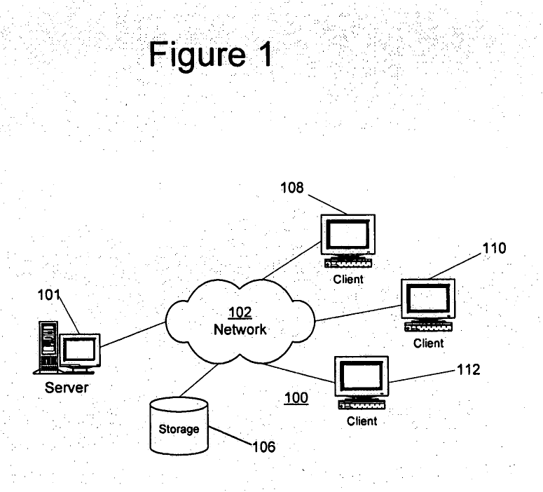

FIG. 1 is a pictorial representation of a network of data processing systems in which the present disclosure may be implemented. A data processing system 100 includes a network 102, which is the medium used to provide communications links between various devices and computers connected together within the data processing system 100. Network 102 may include connections such as wire, wireless, or fiber optic cables.

In the depicted example, a server 101 is coupled to the network 102 along with a storage unit 106. In addition, clients 108, 110, and 112 are coupled to the network 102. These clients 108, 110, and 112 may be, for example, personal computers or network computers. In the depicted example, server 104 provides data, such as boot files, operating system images, and applications to the clients 108-112. Clients 108, 110, and 112 are clients to the server 104. Network data processing system 100 may include additional servers, clients, and other devices not shown. Aspects of the present disclosure may be implemented within a client, such as client 108, 110, and 112, or a server, such as server 104.

In the depicted example, network 102 may include the Internet and/or a collection of networks and gateways that use such things as a Transmission Control Protocol/Internet Protocol (TCP/IP) suite of protocols to communicate with one another. In another example, the network 102 may include a number of different types of networks, such as a local area network (LAN), or a wide area network (WAN). FIG. 1 is intended as an example, and not as an architectural limitation for the present disclosure.

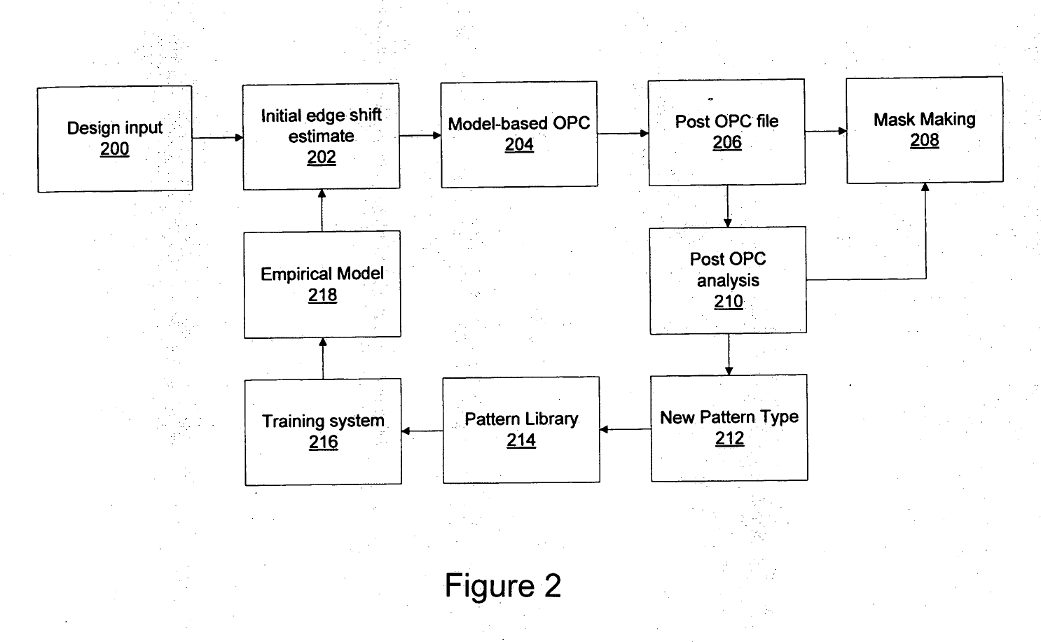

FIG. 2 is a block diagram of an embodiment of an intelligent model-based OPC. One or more blocks in FIG. 2 may be implemented in one or more data processing systems, such as client 108, 110, and 112, and server 104. As shown in FIG. 2, a design input 200 provides target positions for a pattern. The pattern may be provided in GDS II format, or other format as desired. An initial edge shift estimate mechanism 202 provides an initial edge shift estimate for each edge of the pattern. Conventionally, the initial edge shift estimate for each edge would be set to zero. However, in the present embodiment, the intelligent model-based OPC uses an empirical model 218 to set the initial edge shift, discussed in greater detail below.

Next, a model-based OPC routine 204 is executed, in which the mask layout is distorted to accomplish the layout fidelity on the wafer. The model-based OPC routine 204 generates a post OPC file 206 with a final edge shift. The post OPC file 206 can be used for a mask making operation 208. In addition, the post OPC file 206 is provided to a post OPC analysis routine 210, in which the information in the post OPC file is examined and a determination is made as to whether the difference between the final edge shift and the initial edge shift is greater than a tolerance. A tolerance is a maximum tolerable limit for edge shifts.
Final_edge_shift-initial_edge-shift>tolerance

If the difference between the final edge shift and the initial edge shift is not greater than the tolerance, the intelligent model-based OPC continues to the mask making operation 208. However, if the difference between the final edge shift and the initial edge shift is greater than the tolerance, a new pattern type 212 is created based on the information in the post OPC file. The new pattern type 212 is provided to a pattern library 214 (or a previous pattern type is updated) for future training sets. The pattern library 214 comprises many different patterns that are generated as a result of model-based OPCs.

Once the pattern library 214 is updated, training sets are generated based on the new pattern library and are provided to a training system 216. The training system 216 may be an artificial neural network or other training mechanism, discussed in greater detail below. Next, the empirical model 218 uses training system 216 to predict an updated initial edge shift estimate 202 for each edge of the pattern. The initial edge shift estimate 202 is then provided to the model-based OPC 204, as described above. As a result of the intelligent model-based OPC, good initial edge shift estimates can be generated as the empirical model 218 is improved.

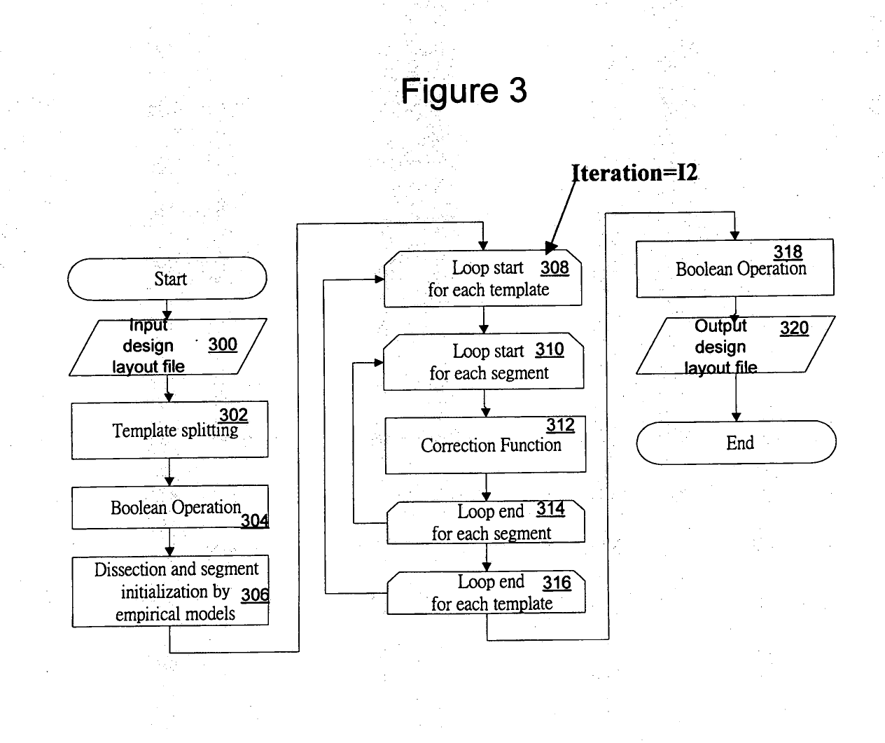

FIG. 3 is a process flowchart of an embodiment of the intelligent model-based OPC of FIG. 2. As shown in FIG. 3, the process begins at step 300 where an input design layout file is received. Execution proceeds to step 302, where a design layout is split into a number of templates. At step 304, execution proceeds to perform Boolean operations, such as AND, NOT, and OR. Boolean operations are multi-purpose operations. Unfavorable jogs and pattern splits owing to the pre-procession of layout files, such as shrinking, may be eliminated by the Boolean operations.

Once the Boolean operations are performed, execution proceeds to step 306, where edges of the patterns are dissected into small segments and assigned initial edge shift estimates provided by the empirical model 218 (FIG. 2). The empirical model 218 uses results of estimating functions performed by the training system, such as the training system 216 of FIG. 2, to predict initial edge shift estimates, and its accuracy is continuously improved as new patterns are added to the pattern library 214. The pattern being corrected can be divided into templates and segments, and a first loop 308 operates for each template of the pattern and a nested loop 310 operates on each segment of a template. Nested loop 310 may have one or more iterations based on different correction algorithm.

Within the second loop, execution proceeds to step 312, where the model-based OPC is performed by applying a correction function to the segment. The first loop is repeated at step 314 for each segment, and the second loop is repeated at step 316 for each template. At step 318, Boolean operations are performed on the results of the second loop and execution proceeds to step 320, where an output design layout file is generated. By using the empirical model's initial edge shift estimates, the number of first loop iterations, 12, required to reach a convergence is greatly reduced. In this way, cycle time and computing resources required are also reduced.

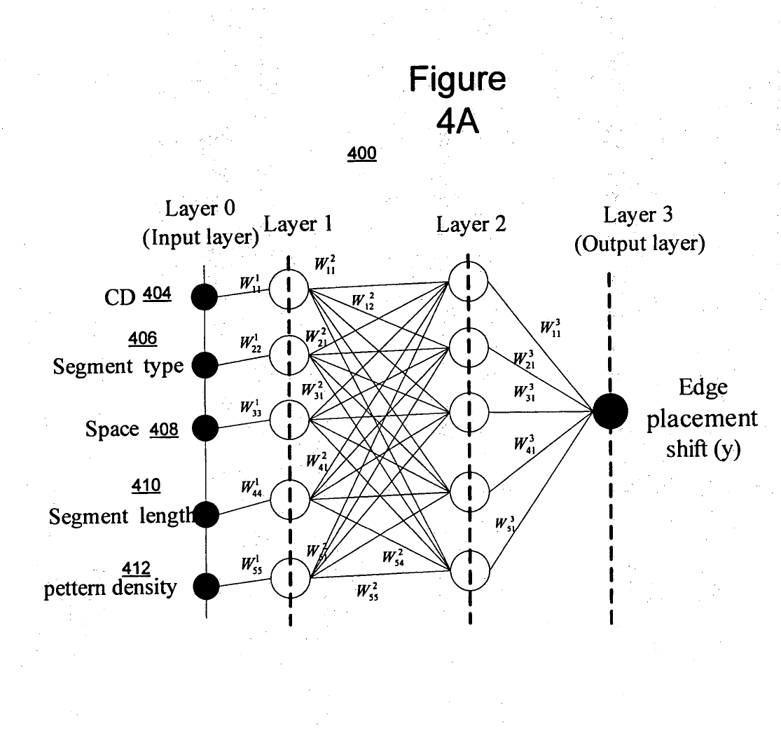

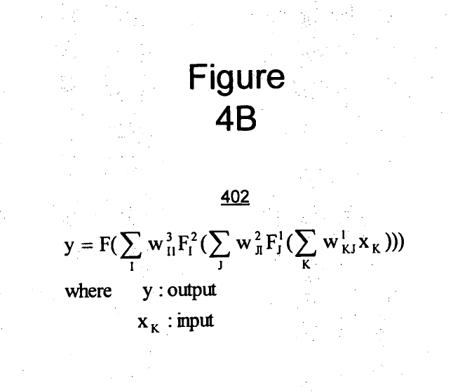

FIG. 4A is a diagram illustrating an exemplary artificial neural network (ANN) 400 used as a training system of an embodiment of the intelligent model-based OPC of FIG. 2. ANN 400 is an interconnected group of artificial neurons that uses a mathematical or computational model for information processing based on a connectionist approach to computation. Typically, there are at least three layers to a feedforward artificial neural network: an input layer, a hidden layer, and an output layer.

In this example, the input layer, layer 0, is a data vector that is fed into the network. Data vector that is fed into layer 0 include process parameters, such as critical dimensions 404, segment type 406, space 408, segment length 410, and pattern density 412. Data vector may include other process parameters without departing the spirit and scope of the present disclosure. When edges are dissected into small segments, each segment is assigned a segment type 406. Segment length 410 is the length of each segment. Pattern density 412 indicates the effective area of neighboring polygons. Space is the effective spacing between a target edge and its neighboring edge. Layer 0 feeds into the hidden layers, layer 1 and 2, which feed into the output layer, layer 3. The actual processing in the network occurs in the nodes of the hidden layers, layer 1 and 2, and the output layer, layer 3.

When enough neurons are connected together in the layers, ANN 400 can be trained to perform estimating functions using a training function. More details regarding the training function are discussed below with reference to FIG. 4B. To provide good initial edge shift estimates, ANN 400 uses corrected patterns from the post OPC file to calibrate the empirical model. The empirical model then provides initial edge placement shift (y) for an input set. Information regarding an artificial neural network may be obtained from “An Optimal Neural Network Process Model for Plasma Etching” by Byungwhan Kim and Garry May, which is incorporated herein by reference.

FIG. 4B is a diagram of an exemplary training function 402 for use by artificial neural network 400. As shown in FIG. 4B, the training function 402 can be any mathematical function used to predict an edge placement shift in a training system. Training function 402 produces an estimate of initial placement shift (y).

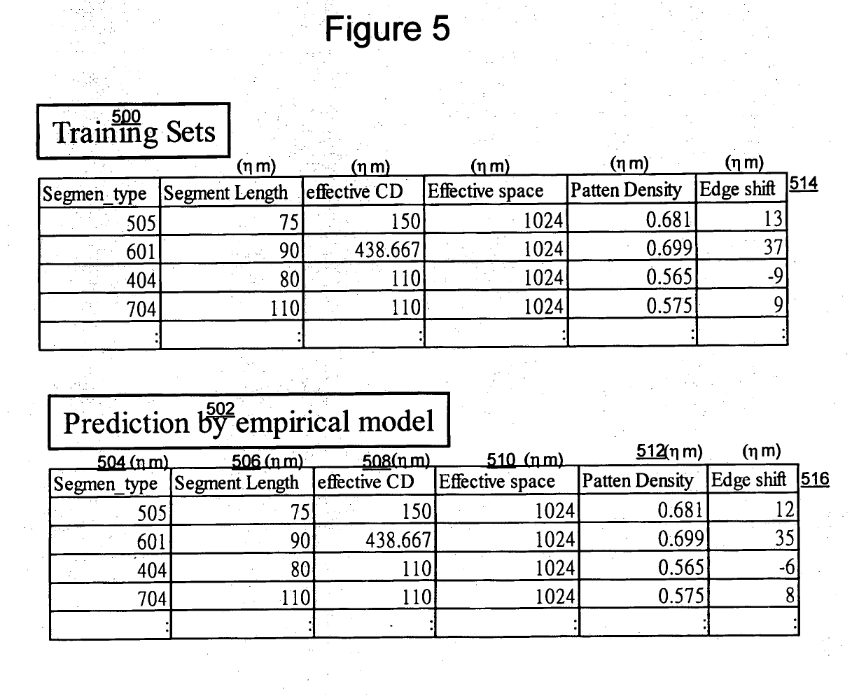

FIG. 5 is a diagram illustrating an exemplary initial training set 500 of the empirical model 218 and good initial estimates of edge shift 516 predicted by the empirical model. For the sake of reference, a final edge shift 514 is illustrated. In this example, segment type 505 has a final edge shift of 13 ηm, segment type 601 has a final edge shift of 37 ηm, segment type 404 has a final edge shift of −9 ηm, and segment type 704 has a final edge shift of 9 ηm. It is desired to realize the final edge shift 514 with a reduced amount of processing.

With the intelligent model-based OPC, good initial estimates of edge shifts 516 can be made using ANN 400. In this example, a data vector that is fed into the input layer of ANN 400 in FIG. 4 includes segment type 504, segment length 506, effective critical dimensions (CD) 508, effective space 510, and pattern density 512. Based on the data vector, ANN 400 in FIG. 4 performs estimating functions using a training function, such as training function 402, and generates initial edge placement shift estimates 516. In this example, segment type 505 has an initial edges shift estimate of 12 μm, segment type 601 has an initial edges shift estimate of 35 ηm, segment type 404 has an initial edges shift estimate of −6 ηm, and segment type 704 has an initial edge shift estimate of 8 ηm. By having good initial estimates of edge shifts 516, the final edge shift 514 can be realized with a reduced amount of processing.

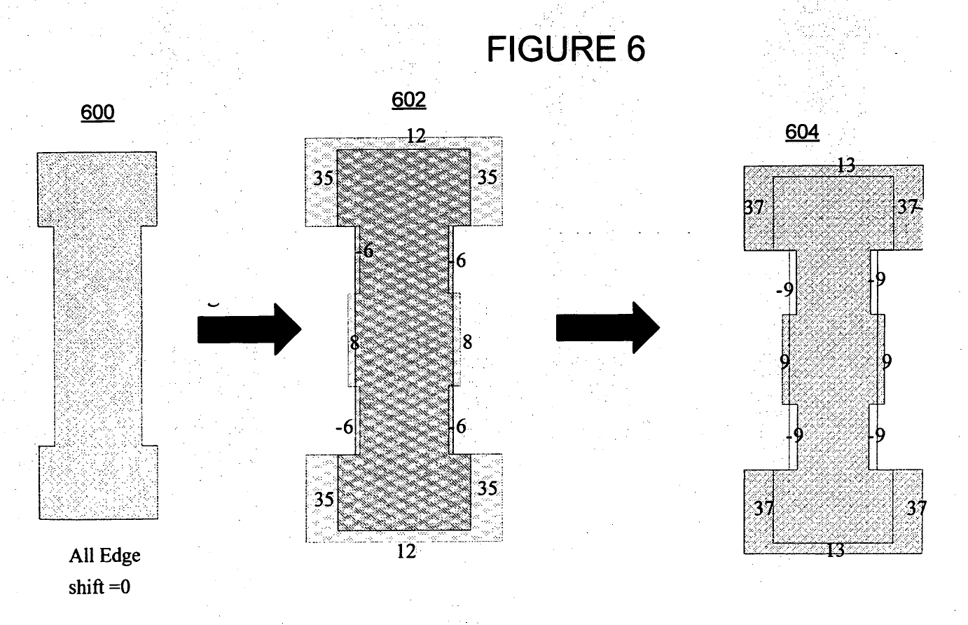

FIG. 6 is a diagram illustrating a design input 600 with no OPC. A good initial estimate of edge shifts provides the initial edge shifted design 602. Using the intelligent model-based OPC of FIG. 2, a convergence is reached and final edge shifts 604 are determined. In the present example, the final edge shifts 604 are determined after three iterations intelligent model-based OPC. Thus, using the initial edge shift estimates produced by the empirical model, a significantly few number of iterations are required to reach a convergence because the initial edge shift estimates are substantially close to the final edge shifts. This leads to a reduction in cycle time and computing resources.

In summary, aspects of the present disclosure provide an intelligent model-based OPC that predicts initial edge shift estimates based on an empirical model. The empirical model can be trained with corrected patterns using a training system, such as ANN. With initial edge shift estimates substantially close to the final edge shifts, the number of iterations required to reach a convergence is reduced. In addition to estimating edge shifts, the aspects of the present disclosure may be extended to other applications, such as predicting etching biases or critical dimension variations after chemical mechanical planarization (CMP). In this way, less iterations are required to reach a convergence and less resources and cycle time are required.

Embodiments of the present disclosure can take the form of an entirely hardware embodiment, an entirely software embodiment, or an embodiment containing both hardware and software elements. An embodiment of the present disclosure is implemented in software, which includes but is not limited to firmware, resident software, microcode, etc.

Furthermore, the present disclosure can take the form of a computer program product accessible from a tangible computer-usable or computer-readable medium providing program code for use by or in connection with a computer or any instruction execution system. For the purposes of this description, a tangible computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, a semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital video disc (DVD).

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

1. A method for generating an output layout file for an integrated circuit chip design, the method comprising:
receiving an input layout from an input layout file;
generating an initial edge shift estimate for each segment of the input layout using an empirical model; and
generating a final edge shift for each segment of an output layout based on the initial edge shift estimate to form an output layout file.

2. The method of claim 1, wherein the generating an initial edge shift estimate comprises:
providing a training set to a training system using patterns in a pattern library; and
performing estimating functions in the training system based on the training set.

3. (canceled)

4. The method of claim 21, further comprising:
updating a pattern library with the corrected pattern; and
generating a new training set for a training system, wherein the training system performs estimating functions to provide the initial edge shift estimate to the empirical model.

5. The method of claim 2, wherein the training system is an artificial neural network.

6. The method of claim 1, wherein the initial edge shift estimate is substantially close to the final edge shift.

7. The method of claim 1, wherein generating the final edge shift based on the initial edge shift estimate requires less iterations than generating the final edge shift based on a zero initial edge shift.

8. An output layout file generation system comprising:
an estimator for estimating an initial edge shift for each segment of an input layout of an integrated circuit chip design from an input layout file; and
a generator for generating an output layout file comprising a final edge shift for each segment of an output layout based on the initial edge shift.

9. The output layout file generation system of claim 8, wherein the estimator comprises a pattern library and a training system.

10. The output layout file generation system of claim 9, wherein the training system comprises an empirical model for predicting the initial edge shift based on a result of estimating functions performed by the training system.

11. The output layout file generation system of claim 9, wherein the pattern library comprises a corrected pattern, wherein the corrected pattern is added to the pattern library from the output layout file if a difference between the final edge shift and the initial edge shift is greater than a tolerance.

12. The output layout file generation system of claim 9, wherein the training system is continuously trained by a training set, wherein the training set is generated based on corrected patterns in the pattern library.

13. The output layout file generation system of claim 9, wherein the training system is an artificial neural network.

14. The output layout file generation system of claim 8, wherein the initial edge shift is substantially close to the final edge shift.

15. The output layout file generation system of claim 8, wherein the generator generates the final edge shift based on the initial edge shift with less iterations than the final edge shift generated based on a zero initial edge shift.

16. A system for generating an output layout file for an integrated circuit chip design, the system comprising:
means for receiving an input layout from an input layout file;
an empirical model for generating an initial edge shift estimate for each segment of the input layout; and
an optical proximity correction mechanism for generating a final edge shift for each segment of an output layout based on the initial edge shift estimate to form an output layout file.

17. The system of claim 16 further comprising:
a training system for receiving one or more training sets from a pattern library and performing estimating functions based on one or more training sets, the estimating functions for use by the empirical model.

18. The system of claim 17 further comprising:
means for determining if a difference between the final edge shift and the initial edge shift estimate is greater than a tolerance, and if so, providing the final edge shift to the training system.

19. The system of claim 18, further comprising:
a pattern library for receiving the final edge shift and generating a new training set for the training system.

20. The method of claim 2, wherein the generating an initial edge shift estimate further comprises:
providing a result of the estimating functions to the empirical model; and
generating the initial edge shift estimate based on the result of the estimating functions.

21. The method of claim 1, further comprising:
determining if a difference between the final edge shift and the initial edge shift estimate is greater than a tolerance; and
if a difference between the final edge shift and the initial edge shift estimate is greater than a tolerance, determining a corrected pattern from the output layout file.
